(19) United States
(12) Patent Application Publication
(10) Pub. No.: US 2009/0058679 A1
(43) Pub. Date: Mar. 5, 2009

(54) Processor-Controlled Receiving Unit for Navigation Data and Method for Transmitting and Processing Navigation Data

(75) Inventors: Martin Lauterbach, Aachen (DE); Maria-Dolores Soriano-Lopez, Aachen (DE)

Correspondence Address: BROOKS KUSHMAN P.C., 1000 TOWN CENTER, TWENTY-SECOND FLOOR, SOUTHFIELD, MI, 48075, US

(73) Assignee: INVENTIS GMBH, Aachen (DE)

(21) Appl. No.: 11/576,513

(22) PCT Filed: Oct. 6, 2005
(86) PCT No.: PCT/DE2005/001789

§ 371 Date: Apr. 2, 2007

(30) Foreign Application Priority Data
Oct. 6, 2004 (DE) 10 2004 048 894.0

(51) Int. Cl. G08G 1/09; G06G 7/76

(52) U.S. Cl. 340/905; 701/117

(57) ABSTRACT

The processor-controlled receiving unit (1) for navigation data, for example, traffic, position and acceleration information, makes possible a particularly easy to install and easy to operate supply of mobile minicomputers and handheld computers with these input data for navigating vehicles with simultaneously optimal receiving features, in particular, in the event this vehicle was not equipped with such a unit during its manufacture. These features are realized by supplying voltage via a double utilization of the antenna signal line, via solar cells, by using special interface combinations between the receiving unit (1), computer (5) and receiving elements (2, 24, 48), and via a bi-directional short-range radio link that uses more than one frequency for transmitting to the computer (5). Other embodiments describe the arrangement inside units, which can be easily exchanged in the vehicle, such as the antenna or vehicle radio receiver or even inside the computer (5) itself. Special methods for acquiring data, intermediate processing and for transmitting data lead to a simplified use.

The invention relates to a processor-controlled reception unit for navigation data and a method for transmitting to a mobile small computer and processing navigation data in a mobile small computer. The invention allows the provision of input data for navigation for vehicles and methods for navigation, traffic-dependent navigation and a method for traffic-dependent determination of the optimum departure time or a timely reminder alarm.

The input data provided by the processor-controlled reception unit (1) for navigation, subsequently called navigation data, comprise information relating to the current geographical position, e.g. in the form of length and breadth coordinates, acceleration values detected using an appropriate sensor in the vehicle, and digital traffic information which is provided by traffic information centers via the Internet and broadcast radio. The invention can also be used for receiving other information, such as weather information. The navigation data are made available to small computers (5) designed for mobile use, e.g. in the form of Personal Digital Assistants (PDAs), or powerful mobile telephones via specially designed interfaces and are processed further there for navigation tasks.

The navigation data required for the use of navigation systems are detected by means of appropriate reception elements for radio signals or sensors. If these are not yet present in the vehicle, retrospective installation and connection to the evaluating computers (5) are required. In previously known reception systems for navigation data, retrospective installation in vehicles causes problems or gives rise to complexity, because they need to be installed at positions with good reception properties in the vehicle or with easy antenna access, and this requires various cables for the antenna, power supply and data coupling with different connectors, depending on the vehicle. Visually inconspicuous cable laying is complex, in some cases impossible and gives rise to considerable complexity. Furthermore, receivers designed for retrospective fitting usually exhibit poorer quality for the delivered data in comparison with permanently installed systems, since compromises are made regarding reception properties.

The use of methods for traffic-dependent and precise navigation is limited in extent or quality on account of these shortcomings, as is a way of triggering an alarm in the computer (5) for the start of the journey in line with the traffic situation.

It is therefore an object of the invention to provide an easy-to-install, easy-to-handle and good-quality supply of navigation data without visually conspicuous cable laying for small computers (5) designed for mobile use or computer-based equipment combinations which meet the requirements described for mobility and computation power and hence to allow the use of methods for precise, traffic-dependent navigation and a method for traffic-dependent determination of the optimum departure time.

The object is achieved by the features of claims 1, 3, 5, 7, 9, 11, 13, 15, 16, 19, 24, 26, 34, 35, 37, 41.

The invention advantageously makes use of the availability of the antenna signal and the power supply at the same location at particular points in the vehicle by arranging the reception circuit at these points and spanning the distance to the computer (5) using a specifically designed shorthaul radio link to the computer (5).

Specific embodiments provide for the receiver to be combined with parts of the vehicle broadcast radio reception system, such as with the vehicle broadcast radio receiver (9), with the antenna signal line (12) or with an antenna amplifier (33) integrated in the antenna base. One embodiment describes a novel, combined appliance which has both the properties of a mobile small computer and those of a traffic information receiver or a position receiver assisted by acceleration measurement.

One particular property of the invention is the simple retrofitability in motor vehicles as a result of a reduction in the number of necessary cable connections with a simultaneous improvement in reception properties and handling of the appliance and the information provided. Handling is simplified by virtue of simple coupling to the associated computer (5), by virtue of automation of the reception control, such as by virtue of automatic transmitter searching, and by virtue of convenient management of all the information already received even before coupling to the computer (5). The use of special shorthaul radio transmission methods for transmitting the received data to the computer (5) via the interfaces (4) and (7) achieves a high level of interference resistance. At the same time, limiting the transmission power reduces the interference radiation and hence the possible effect on humans and also interference with other systems.

Installation complexity is avoided by dispensing with the cable connections for the supply voltage and the antenna signal, e.g. through dual use of the vehicle antenna signal line (12), which, in combination with the special shorthaul radio transmission methods for the data transmission to the computer (5), ideally saves having to install new cables.

For another embodiment, the reception unit is combined with solar cells and this in turn saves power supply cables. Particularly when combined with satellite receivers, this affords particular advantages, since solar cells and position information receivers make similar demands on the operating conditions. Since both require the greatest possible free visual range to the sky, they can also be coupled mechanically to one unit, which allows a particularly compact wireless design.

The received data are transmitted to the evaluating computer (5) via a radio link. To avoid the interface bottlenecks which have existed to date when connecting the reception unit (1) to a computer (5), the invention uses an interface with a star-like bus architecture in addition to the radio link, as a further embodiment. If a position information receiver is already present, a special transmission protocol is used which allows both position information and traffic information or other information to be requested via the interface (4) in the reception unit. This also allows retrospective connection of further reception elements to the reception unit (1), e.g. via a serial interface (36), so that this can also be used for transmitting the data to the computer (5) via a single interface (4) or (7). This is advantageous on account of the usual scarcity of interfaces on small computers.

One embodiment provides a small hand-held computer (5) for personal needs which contains the full reception unit (1) with the reception elements for traffic information or acceleration which are required for exact traffic-dependent navigation, also in combination with a position receiver, permanently integrated in the computer housing.

The use of the embodiments described allows reliable implementation of methods for traffic-dependent navigation and also for traffic-dependent calculation of the optimum departure time in mobile computers (5). This affords a significant increase in convenience of use for the user.

### PRIOR ART

Small computers (5) designed for mobile use can be used for navigation tasks in motor vehicles, in other means of locomotion and also for pedestrians. For navigation, these appliances require external information, such as information about the current geocoordinates or, in the case of motor vehicles, information about the current traffic situation. The coordinates can be ascertained via satellite receivers using the Global Positioning System (GPS), for example. Traffic information is available via various information channels. These may be the Traffic Message Channel (CMC) or else information provided via the Internet or mobile radio, for example. Other data assisting navigation are acceleration values in various axle directions or around various axles, for example.

Previously known reception elements or sensors can be connected to the computer performing the further processing by means of various cables. Retrospective installation requires additional cables to be laid with installation elements suited according to vehicle type for a broadcast radio antenna and for the power supply and also plug connectors which are dependent on the type of computer (5) used for navigation and electrical interfaces for forwarding the digital useful signal obtained.

For the technical implementation, the solutions described below are known for supplying navigation systems with position and traffic information. None of the known technical implementations provides a solution for simple retrospective installation with an easily installable and reliable power and data supply in motor vehicles with simultaneously optimum reception conditions for position and traffic information.

DE 100 08 454 A1 describes a multifunctional navigation appliance which, within a housing frame, couples a mobile data processing unit such as a personal digital assistant (PDA) to a position finding unit and a mobile telephone. Provision is made for it to be coupled to an existing car radio. This arrangement presupposes that the existing broadcast radio receiver is able to receive traffic information, e.g. via the Radio Data System (RDS), and has a suitable interface for transfer to the navigation computer used. The arrangement affords the option of simple retrofitting of portable computers for navigation. For installing the apparatus itself, however, the cabling complexity remains considerable.

DE 199 21 533 C1 describes a communication system for motor vehicles which sets up a radio data transmission link to a mobile telephone. The radio data transmission link is provided in order to implement telephone calls via the vehicle audio system and hence to achieve simpler operator control and acoustics during the journey. In one particular embodiment, provision is made for the communication system to be designed to forward traffic information to a navigation system or to contain a navigation system. However, there is no description of how to simplify the data connection and power supply during retrospective installation.

DE 102 20 304 A1 describes on-board electronics for a motor vehicle which set up communication with a Personal Digital Assistant (PDA) also by radio, inter alia. This arrangement has no provision for sending traffic information to the PDA, but rather it is only possible to send addresses and appointments from the PDA to the on-board electronics, which in turn forward these to a navigation appliance. The navigation is hard-wired to the on-board electronics. There is no provision for navigation in the PDA and also transmission of the traffic information to the PDA.

DE 198 06 430 A 1 describes a broadcast radio receiver which is to be connected into the antenna cable and which is able to receive data using RDS. The received data are fed into the broadcast radio signal, and hence again within the broadcast radio frequency band, on another frequency, so that it is also possible to present RDS data when another frequency is set in the vehicle broadcast radio receiver. There is no provision for the traffic information to be transmitted to the PDA.

EP 1 347 428 A 1 describes the combination of the data stream from two data sources for position information receivers (GPS) and traffic information receivers into one data stream which can be transmitted via a serial line or interface. This means that if there is an insufficient number of interfaces available on the computer or personal digital system (PDA) used for navigation, simultaneous reception of position data (GPS) and traffic information (RDS-TMC) is made possible via a serial interface. The process uses a special method to combine the two data streams when fed into the common data line and to split them again through appropriate decoding after transmission. This does not allow a specific request just for the traffic information or just for the GPS data, but rather the data are transmitted in combined form regardless of the needs of the reception unit.

DE 202 08 780 U1 and EP0867851 describe arrangements for transmitting traffic information from a traffic radio receiver to a PC via a serial interface.

U.S. Pat. No. 6,757,262 describes a universal system for combining a wide variety of data in vehicles for use in navigation systems and driver information systems. Incorporation of a PDA as a vehicle peripheral device into the information system is described.

JP 10-084398 describes a unit for combining a plurality of traffic information streams via an interface to form one data stream. In this context, the data streams applied to the input of the unit are buffer-stored in buffers and are then forwarded to a navigation unit in combined form.

JP 2001-256593 describes a method for obtaining traffic information quickly after getting into the vehicle. This is achieved by a special logic section for providing the receiver with a supply voltage in timely fashion.

KR 9709165 describes a stationary receiver for traffic information which forwards the information by pager to other, possibly moving, receivers.

JP 10283591 describes a method which is used to supply traffic information received by radio to a navigation appliance via a wired interface so as to make the route planning dynamic, i.e. dependent on the traffic situation. In particular, a method is described for using an interpolation method to calculate the speed of travel to be expected for distances on the route without available traffic information.

EP 1 557 689 A1 describes the design of a receiver for receiving satellite-assisted navigation signals and also a navigation system. This embodiment is based on a satellite-assisted position receiver, included as a fixed component. In this case, an interface is provided which allows the use of plug-in modules with a traffic information receiver or an independent power supply. An embodiment without a position receiver is not described and is also not possible to achieve with this embodiment.

A known embodiment of a GPS receiver combined with a traffic information receiver reduces the number of cables and interfaces required by combining the data streams from GPS and traffic radio to form one data stream. This provides the traffic information in a data stream mixed with GPS data. This does not allow the traffic information receiver to be operated without a GPS receiver or without GPS reception.

This solution is undesirable when, by way of example, position data are already available elsewhere, e.g. when a vehicle, vehicle antenna or mobile telephone already has a built-in GPS receiver which only needs to be coupled to the navigation unit. Often, combined installation in the vehicle does not make sense, since the broadcast radio antenna signal can be obtained at the locations in the vehicle interior at which satellite reception is good, e.g. beneath the windscreen or the rear window, only using an additional cable.

Hence, a wide variety of ways are known for detecting position information or traffic information or other information and supplying it to navigation appliances and interpreting it in these. The solutions described are usually provided for a fixed installation in vehicles, with various cables and connectors being required for connection. If these devices can actually be fitted in vehicles when the vehicle is manufactured then this is less of a problem.

The availability of very small computers with a high level of computation power which can be fitted in the vehicle with little complexity and increasingly can also be used as a computer (5) for navigation tasks makes new demands on the peripheral area required for navigation. Principal requirements are ease of installation in the vehicle and simultaneously reliable functionality and ease of use.

The aim is to optimize the contrastingly oriented parameters of “low installation complexity” and “high level of functionality” simultaneously.

The installation complexity is determined by the number and complexity of the cables to be laid for the power supply, antenna feed and data connection, by the compatibility of the connections required and by the space requirement and necessary physical changes to the vehicle.

The functionality is determined by reception quality, which is heavily dependent on the orientation of the antennas or the usability of existing antenna signal lines. Other quality features are rapid availability, completeness and correctness of the received information. Particularly when coupling to the computer by radio, it is advantageous for the receiver to start operation in timely fashion even before the coupling.

For retrofitting in vehicles, known embodiments require cables for the antenna, power supply and data line. In some cases, storage batteries are used in order to save on power supply cables. This restricts the operating period, since the storage batteries need to be recharged when required using an additional cable.

Known traffic radio receivers for supplying mobile small computers are not capable of receiving traffic information independently of the receiving navigation computer, and keeping it for short-term interrogation by the navigation computer, even when said navigation computer is not yet coupled or not yet turned on. This is a drawback when using portable computers, since these are fitted in the vehicle again and coupled to the receivers again at the start of every journey.

This restricts the functionality in the operational startup phase. The invention solves this problem by virtue of the reception unit (1) starting operation and gathering traffic information independently of the coupling to the computer (5).

When a connection is set up, these data are then available immediately and can be requested by the computer (5) at high speed. This saves the possibility of route changes being required which arise on the basis of the previous prior art when the stock of traffic information data is not known until later, e.g. after the journey has started. Finally, minimization of the production and materials costs is very significant as soon as the invention is used in larger item numbers.

### OBJECT

Against the background of the existing prior art, the present invention is based on the object of making traffic information received by broadcast radio and, by way of example, position data ascertained through satellite reception available to computers (5) which, in particular, are retrospectively or not permanently fitted in the vehicle for traffic-dependent navigation or for other calculations and optimization operations which are dependent on the currently received data. At the same time, the aim is both to minimize the complexity required for installing the reception device and to ensure optimum reception and application quality. This is done using techniques which, in their specific and new combination, provide a particularly compact, easy-to-install and easy-to-use unit with improved functionality.

Through multiple use of the available cables, through the use of reduced-interference short-range radio technology and through particular forms of arrangement, the invention avoids the need to lay new cables and antennas and at the same time provides optimum reception conditions.

Small computers designed for mobile use, such as Personal Digital Assistants (PDA) and mobile telephones, are distinguished by their handiness and increasingly also by their performance, which allows them to be used as navigation computers. One particular advantage is their mobile and versatile opportunities for use. In comparison with fixed navigation installations in vehicles, they have specific other properties, which result in special demands on the coupling of the requisite peripheral area, such as traffic information receivers and position information receivers.

The appliances, in this case called computers (5), have the following properties:
portability: can usually be accommodated in a jacket pocket,
can be fitted in the dashboard area of vehicles using a small bracket and can be detached again without tools, so that they are available for use in different vehicles, for example,
light weight of no more than approximately 200 g to 300 g,
color screen, which also allows map display, e.g. for visually displaying traffic obstacles and alternative routes,
built-solid state memory which retains the memory content without any moving parts and when no power is supplied (e.g. FLASH memory),
at least one externally accessible slot for memory expansions which retain the memory content even when no power is supplied,
built-in storage battery or other mobile power supply.

Other requirements for mobile use may be:
operator control using a touch-sensitive screen,
transmission and reception unit for mobile radio, so that the appliance can also be used for telephony. In this case, the dialing process can be performed using a touch-sensitive screen or using keys or by means of voice signals,
permanently installed software programs for personal task, appointment and e-mail management,
at least one expansion slot whose interface also allows plug-in cards for other functions to be included.

Traffic information is provided by traffic information centers via various channels. This information can be retrieved from the servers provided for this purpose using the Internet and hence also by means of wireless mobile Internet access from the traveling vehicle. This can be done using mobile radio receivers with radio data transmission capability as reception element (2). In this case, the information is retrieved by every subscribing receiver, e.g. using GPRS, individually at arbitrarily selectable times. Since this function can already be performed with available mobile telephones without any additional technical complexity, this route appears inexpensive and simple at first. However, the data link which needs to be set up individually by every vehicle and upon every request means that it is very complex and hence continually very costly.

In contrast to point-to-point connection, broadcast radio transmission typically sets up unidirectional connections from one transmission point to a large number of reception points in parallel. Typical broadcast radio transmission is that of audio radio broadcasting, which transmits one program to a large number of listeners. Another property of broadcast radio links is that the transmission takes place in one direction from a transmitter to a large number of receivers.

One special type of broadcast radio transmission is unidirectional cell broadcasting in mobile radio cells. In this case too, information is transmitted from one transmitter to a larger number of receivers. It is distinguished from bidirectional point-to-point data links by mobile radio, which usually also result in much higher cost.

The invention focuses on reception of traffic information transmitted by (audio) radio broadcasting.

In this case too, traffic information is understood to mean only information about the traffic situation and hence about the speed of travel which can be expected on defined road sections. This is distinguished elementarily from route information, which is produced taking account of the traffic situation.

Route information taking account of the traffic situation describes selected journey routes on which a relatively good flow of traffic can be expected according to the present level of information.

At present, this can be done using UHF (FM) carrier signals which transmit the analog radio program and additionally data using the RDS (Radio Data System). A subset of these data transmitted using RDS uses the TMC (Traffic Message Channel) method to encode traffic information in a very compact form. Decoding requires special receivers. To receive and decode the Traffic Message Channel (TMC), for example, a reception element (2) comprising a receiver (34) for FM signals and a decoder (35) for RDS (FIG. 9) is used. The rest of the decoding is done by filtering out the desired data packets, e.g. the traffic information. In this phase, the traffic messages are available in a very compact form. To limit the complexity of transmission to the computer (5), it is appropriate to transfer the data in the form of this TMC raw data stream to the computer (5) for further evaluation. Through a combination with reference lists for the geographical association (location list) and the association of events (event list), the content of the messages is evaluated. Since the location and event lists are subject to updates over the course of time, it is recommended that these lists be stored in rewritable memory, for example provided by the computer (5). Apart from RDS (based on DIN EN 62106) in combination with TMC (based on ISO 14819-1-3), it is also possible to use TPEG (e.g. based on CEN ISO TS 18234 ff. and ISO TS 24530 ff./www.tpeg.org) or another method for the encoding. The encoding currently taking place on the basis of the TMC method will in future be placed by TPEG encoding, which removes certain limits from the TMC method. Similarly, it can also be expected that analog broadcast radio transmission as a carrier will be replaced by fully digital transmission, e.g. the DAB or else DVB-T method. This variant embodiment is therefore also provided for the reception element (2).

The analog FM broadcast radio signal is usually transmitted in a frequency range between 70 and 120 MHz.

Transmission using mobile radio cells is implemented at frequencies around 900 MHz, 1800 MHz or above 2000 MHz. Digital radio (DAB) is in the ranges from 174 MHz to 230 MHz and 1450 MHz to 1470 MHz, for example. The reception element (2) needs to be designed for these frequency ranges accordingly.

Geographical coordinates can be ascertained using position information receivers, for example, which use satellite systems such as GPS (Global Positioning System), Galileo or Glonass. Position receivers are currently usually in the form of receivers for the GPS system. Usual appliances have a serial interface for point-to-point connections.

It is also possible to use position information receivers which evaluate the signals from terrestrial reference transmitters instead of from satellites. By way of example, this is done by determining the distance to mobile radio transmission stations from the signal propagation time and referencing the known geographical coordinates of the respective transmission station. The position finding receivers used for this purpose are currently even less accurate than the satellite-based versions.

For situations in which the reception of a reception element (48) for position information is interrupted, the detection and processing of the acceleration effected using the vehicle provide a way of ascertaining position changes by computer. To this end, the movement changes detected using an acceleration sensor are taken into account, on the basis of the last known movement vector, with the distance which is currently to be traveled and the vehicle position is inferred from this.

To this end, the acceleration measured is integrated over time. This gives the change of speed over the same time in the direction of the change of acceleration.

The vehicle speed in turn is obtained from the speed at the start of integration and the calculated speed change. A change in the position in turn can be calculated from the original position at the start of the measurement and the integral of the speed over time. So long as the vehicle is on a prescribed route, it is possible to assume a change in position along this route. To compensate for the influences of vehicle inclination or gradient of the journey section, it is in turn possible to measure acceleration values in several axle directions or changes in the angular speed around several axles and to include them in the calculation. By taking account of the gravity component, this determines the acceleration in the direction of travel more exactly.

In contrast to a bus interface, e.g. also in contrast to the “Universal Serial Bus” (USB) interface, the interface denoted generally by “serial interface” has the property that it can be used to set up only point-to-point connections. This means that it is also possible for just one peripheral device to be connected to a “serial interface” (for point-to-point connections) on the computer (5). A typical embodiment of the serial interface is the RS 232 interface.

Ideally, navigation appliances for road vehicles are supplied with traffic information and other information, such as acceleration information, beyond the information relating to the current position. This allows the current traffic situation to be taken into account in route determination and in the estimation of journey time. However, small computers (5) usually have at most one serial interface for point-to-point connections, so that it is not possible to connect a plurality of reception appliances simultaneously. To transfer position data, traffic information and other external data, such as sensor data, to the computer, particular measures are therefore needed. New embodiments are now described which solve this problem in different ways:

One embodiment uses a bus system with star-like topology instead of the previously usual serial interface, which means that a plurality of peripheral devices can be connected to a computer (5) at the same time. The star architecture affords the advantage of simple cable laying, e.g. in contrast to a ring bus, in which all the peripheral devices are connected to one long line which normally needs to be closed to form a ring.

A star topology is therefore much better for retrospective cabling of additional devices. In contrast to this, the ring structure affords advantages when cabling up devices during the actual vehicle manufacture, since one line can be used to cable up a large number of devices, which also presupposes that the cable run is routed via a well-planned path, however.

A system which affords this star architecture is the Universal Serial Bus (USB), which is able to use one interface to address various peripheral devices and to communicate with them bidirectionally.

The novel embodiment of a reception unit (1) with a reception element (2) for traffic information or with a reception element (48) for acceleration information in the form of a sensor for accelerations in or around a plurality of axles, combined with a bus interface based on star topology, such as the Universal Serial Bus (USB), for coupling to a computer (5), is advantageous both with wired and wireless connection. This also applies to the combination said reception elements (2) and (48) with a reception element (24) for position information.

Another embodiment, which on the one hand solves the problem of the limited number of interfaces but also allows further use of available reception elements (2, 24, 48) with a serial interface for point-to-point connections, provides a reception unit (1) which has a permanently incorporated reception element (2, 24, 48) and which has at least one further interface (36), besides the interface (4), fitted on it which is in the form of a serial interface available to the user for point-to-point connections, in order to connect reception elements (2, 24, 48) for receiving further navigation data. The data provided by the reception elements (2, 24, 48) are then stored in the memory (14) using a specific method by a program executed in the processor (3) and are provided for interrogation by the computer (5) via the interface (4) (FIG. 2).

As a basic reception element which is permanently incorporated in the reception unit (1), embodiments with the reception element (2) for traffic information, a reception element (24) for position information or a reception element (48) with a sensor system for acceleration information are advantageous. The reception elements advantageous for retrospective connection using the interface (36) which is openly accessible to the user are primarily the other two respective elements, individually or in combination, for each of these reception elements.

One specific embodiment (FIG. 2) of the information provides for, by way of example, a reception unit (1) which contains only a reception element (2) for traffic information to be provided with an additional interface (36) for position information receivers, e.g. the serial interface for point-to-point connections which is usually used for position information receivers, in order to allow both information streams to be interrogated by the interface (4) and hence via a single interface on the basis of the special protocol described when the position information receiver is connected.

This additional interface should be easily accessible to the user and should have suitable plug connectors which are customary on the market. In another advantageous embodiment, the use of the contact pins on the plug connectors can be switched, so that plug connectors from different manufacturers which use different contact assignments can be used easily and without further adapters. A further improvement in applicability is made possible by automatic recognition of the contact assignment of the appliances to be connected and automatic switching of the contact assignment in the reception unit on the basis of this. The external contact assignment is recognized, by way of example, by measuring the voltage level or by recognizing firmly defined digital signals on the lines. The switching is performed by electronically operated switches or transistors.

This embodiment allows a traffic information receiver to be retrofitted when a GPS receiver with a serial interface for point-to-point connections is already provided. In this case, the data from the GPS receiver are made available to the computer (5) by the reception unit (1) via the interface (4) and the interface (7), in the same way as the traffic information and/or possibly acceleration sensor data.

To transfer the data from various reception elements (2, 24, 48) via a single data link, a special transmission method is applied. This is necessary, for example, when there is only one serial interface for point-to-point connections on the computer (5) or no bus connection is used. If a plurality of the reception elements (2) for traffic information, (24) for position information or (48) with a sensor system for acceleration information are connected to the computer (20) via interfaces (37) and (36), transmission of the data from a respective one of the reception elements (2, 24, 48) is prompted by means of control programs in the computer (20) and in the computer (5) on the basis of the requirements of the computer (5). This allows the computer (5) to request the currently required data on the basis of need. To switch the data interrogation to data from another reception element, respective specific commands from the computer (5) to the reception unit (1) are used to prescribe whether only received data from the reception element (2) for traffic information or only from the reception element (24) for position information or other data, e.g. from a reception element (48) for acceleration information or from another element (49), are transmitted. The reception unit (1) uses an acknowledgment signal to confirm whether the request is met. The relevant data are then sent by the reception unit (1).

The transmission method allows the change and the regularity/frequency of transmission of the data from the various reception elements from the computer (20) to the computer (5) to be influenced from the computer (5).

This ensures a rapid change making it possible to change to a different data source within fractions of a second. The change between the data sources becomes a fixed part of the transmission protocol.

Besides the change between the various data sources, provision is also made for data or commands to be transmitted to reception elements in order to control them or to supply them with operating parameters. By way of example, mention may be made of commands for setting the reception frequencies of a reception element (2) or status checks.

In this context, importance is also attached to the design of the interfaces (36). For reception elements which are also intended to receive information or control commands, the interface (36) needs to be provided in bidirectional form so that the data can be transmitted in both directions. For reception elements such as a GPS receiver, which transmit only position data to the connected computer during normal operation, it is advantageous to design the interface (36) in unidirectional form. This is particularly advantageous in the field of microcontroller circuitry around the computer (20), since it is then possible to save valuable port pins on the controller and driver components. It is entirely advantageous to provide a unidirectional interface in this case, even if the counterpart, namely the additionally purchased GPS receiver, independently provides a bidirectional interface as standard. The advantage arises through cost and space savings on the circuit board of the reception unit (1) and can be implemented particularly when it is not necessary to supply the GPS receiver with data via the interface (36).

For the embodiment which provides an interface (36) for additional reception elements, easy access to the interface (36) is provided. To this end, the interface is fitted such that it is easily accessible to the user, where possible without having to open the housing of the reception unit (1). Similarly, provision is made for the connection to be made using standard plug connectors in order to achieve the desired simple handling. It is also necessary to ensure that the signal levels are matched to the level of the serial standard interface RS 232, for example, and electrical safety requirements.

If a position information receiver is already present then it is advantageous to use a pure traffic information receiver which can be coupled to the computer (5) independently of the position information receiver. The traffic information receiver should be installed where there is good access to a broadcast radio antenna signal.

If this is a different location from the location of good satellite reception, the position and traffic information receivers should be separated. Part of the invention therefore involves a pure traffic information receiver with the special property of simple connectability and installability. This receiver is particularly advantageous when the interface (4) is in the form of a shorthaul radio interface using a plurality of frequencies, since in that case any wiring between the traffic information receiver and the computer (5) is dispensed with.

Replacing the wire-base connection by radio links for data transmission via the interfaces (4) and (7) to the computer (5) permits several effects at the same time: The complex and unwanted laying of cables is dispensed with. At the same time, the problem of often incompatible interfaces is reduced because, assuming that the same radio method is being used on both sides, incompatibilities can often be eliminated just by means of software matching. This allows the provider of the hardware to serve connections between appliances from different manufacturers without needing to supply and hold appropriate connectors or adapters. The interface matching can also be carried out largely automatically and without the user noticing.

On the other hand, radio links have the drawback that they are more susceptible to interference, for example, since the enabled frequency ranges may contain other independent connections in parallel which give rise to interference with the transmitted signals. For this reason, the invention described uses a special radio technique to solve this problem.

The use of several frequencies for the carrier signal at the same time (superimposition) or in succession (frequency hopping) reduces interference with competing systems to an acceptable degree, so that customary error correction methods ultimately allow sufficiently low-interference transmission.

For this, the invention involves the use of a special radio link which also allows several peripheral appliances to be connected to one common central computer (star point) and also allows several independent radio data transmission links to be operated at the same location. This is achieved by the following measures:

By selecting a suitably limited transmission power of less than 10 mW, the relatively short distance of one to two meters in the usual instance of application within motor vehicles is bridged by setting up data transmission which gives rise to little interference with other radio transmissions in the same frequency range.

In order to achieve compatibility with radio transmission systems available on the market, it is sometimes also necessary to resort to higher transmission powers of up to 50 mW or 150 mW.

For radio transmission, a method is used which uses a frequency range which is available for license-free use in most countries. These ranges are at 915 MHz in the USA, 868 MHz in Europe, and additionally in ranges higher than 2 GHz worldwide, usually between 2.3 GHz and 2.5 GHz or between 4.7 and 5.5 GHz.

To minimize interference and hence transmission losses, the frequency changing method involves automatically changing the frequency used for transmission, e.g. on the basis of a pseudo-random pattern at short intervals of time, e.g. several times per second. This reduces collisions with extraneous signals during transmission, said extraneous signals coming from other transmission links, for example. Error correction methods ensure complete and very low-error transmission.

For the radio transmission via the interfaces (4) and (7), various methods such as Bluetooth based on 802.15.1, WLAN/WiFi based on 802.11.b, or else the ZigBee method based on 802.15.4 and the successors to these methods may be used.

One variant embodiment for radio transmission via the interfaces (4) and (7) of the computer (5) is to superimpose a plurality of frequencies to form one frequency band. This can be done using the ultra wideband (UWB) method, for example. One variant of this is the spread spectrum method. This does not involve changing between several fixed frequencies, but rather several frequencies are superimposed and as a result a wider frequency band of lower amplitude is used for transmission. This also allows several applications to be operated with immunity to interference at the same time in the same frequency band and at shorter physical distances.

The method affords advantages for the parallel use of a plurality of systems at short range, since it operates at extremely low transmission powers. The low transmission power means that the interference level is so low that sometimes even operation in reserve frequency ranges is tolerated.

A special form of the UWB method which likewise allows a plurality of applications to be operated with interference immunity at the same time in the same frequency band and at short physical distances is the wireless universal serial bus (USB) method. This is called WUSB (Wireless Universal Serial Bus). This also ensures the simultaneous connection of a star point to a plurality of subscribing communication appliances (star topology).

If a radio link is chosen for data transmission then this dispenses with the cable link for providing the supply voltage, since the same cable runs can be used for signal and supply lines.

It is thus particularly advantageous for a radio link to be first used in combination with a suitable power supply which, where possible, requires no new cables.

In this regard, one embodiment uses the cable from the existing vehicle broadcast radio antenna (23) in multiple fashion by using the existing antenna signal line (12) for transmitting the circuit's supply voltage at the same time as for antenna signal transmission in addition. This is done by outputting a DC voltage via a coupling element (13) from the radio-frequency antenna signal, which is input at an easily accessible point, e.g. on or in the vehicle broadcast radio receiver (9), via a coupling element (11). To protect the vehicle broadcast radio receiver (9), the DC voltage is decoupled from the antenna input via a coupling element (41). Customary broadcast radio receivers already have a decoupled antenna input. The arrangement saves the otherwise necessary additional power supply cables. Another advantage is that the available broadcast radio antenna signal is used by the reception element (2) for receiving the traffic information via a coupling element (21). This circuit therefore affords advantages particularly for reception units which evaluate the broadcast radio signal for receiving traffic information.

This embodiment can be applied both for pure traffic information receivers, pure position information receivers and for receivers which provide traffic information combined with position information or in a combination with acceleration information.

In one specific embodiment (FIG. 4), by producing the entire unit in the form of an adapter plug which is connected into the antenna signal line (12) of the existing broadcast radio receiver, retrofitting with simultaneous optimum use of the available antenna signal becomes a very simple matter. This embodiment can be implemented in all combinations of the reception elements (2) for traffic information, (24) for position information and (48) for acceleration information. It makes particular sense to use a design with a reception element (2) for traffic information as a basic element, with which the other two elements (24) and (48) can be combined. For transmission to the computer (5), the radio data transmission link via the interface (4) with the properties already described is used.

Instead of an antenna adapter plug, the mounting base of the vehicle antenna can also be used for accommodation. In this case, combination with an antenna amplifier (33) provides both a good antenna signal and access to the antenna amplifier's supply voltage without laying further cables. This embodiment can be implemented in all combinations of the reception elements (2) for traffic information, (24) for position information and (48) for acceleration information. It makes particular sense to use a design with a reception element (2) for traffic information as a basic element, with which the other two elements (24) and (48) can be combined.

For transmission to the computer (5), the radio data transmission link via the interface (4) with the properties already described is used.

Very simple retrofitting is possible with optimum reception properties, since only customary vehicle components are used.

The coupling elements (11) and (13) need to have particular filter properties by virtue of their being designed not to let high frequencies pass, whereas low frequencies or else a DC voltage are passed. This can be achieved by connecting an inductance, e.g. a coil, in series.

The filter response of the coupling elements (21) and (41) is designed to have opposite filter properties from those of the coupling elements (11) and (13) by designing it to allow high frequencies to pass and not to allow low frequencies to pass. This can be achieved by connecting a capacitance or a capacitor in series.

Another embodiment of nonpermanent installation in vehicles dispenses with the power supply and antenna feed from the antenna cable and instead uses a power supply via solar cells which is buffered by means of a storage battery, so that even phases with no daylight can be spanned. It is crucial for problem-free application to have a compact design, which is achieved by accommodating the necessary components in one cohesive small unit. This embodiment can also be constructed in all combinations of the reception elements (2) for traffic information, (24) for position information and (48) for acceleration information.

Particular advantages are afforded by a combination with a satellite-based position information receiver, since both the position information receiver and solar cells make similar demands on the installation location and orientation by requiring the largest possible optically transparent visual range to the sky for good operation.

The advantage of a solar-powered reception unit (1) which receives traffic radio and transfers the received data to the computer (5) wirelessly and with interference immunity is the totally wiring-free installation and hence the option of being able to remove the appliance from the vehicle again, even easily, in order to use it in another vehicle or outside of the vehicle for traffic information reception, for example.

The combined receiver for traffic and position information can be positioned with a good view of the sky in optimum fashion for satellite reception. The broadcast radio antenna is either connected by means of coaxial cable or is implemented as a provisional throw-out antenna. An advantage of this combination is the compact design, which is very easily portable and hence can also be used in different vehicles.

An embodiment which saves any retrofitting of reception units and at the same time affords the advantages of simple portability is described below. In this embodiment, the computer (5) is from the outset designed such that it both serves the interests of a mobile small computer with management of personal data and meets the requirements of navigation for road vehicles. In this regard, the computer (5) is in the following form:
The computer (5) should approximately be of such a size that it can be accommodated in a shirt pocket. This firstly makes it more portable and secondly means that it restricts the range of vision in the vehicle only to a limited extent.
The computer (5) should be able to be fitted in the dashboard region of vehicles using a small mounting element but should also be able to be detached again without any tools, so that it is also available for use in different vehicles, for example.
Lightweight, i.e. no more than approximately 200 to 300 g. A greater weight restricts portability and makes it more difficult to fit on the dashboard. In addition, large, heavy or inadequately fastened appliances represent a risk in a vehicle in the event of accidents or critical situations.
A color screen which also allows map display, for example allows visual representation of traffic holdups and alternative routes.
Solid state memory of at least 3 Mbytes which is permanently incorporated in the computer (5), which retains the memory content without any mechanically moving parts and when no power is supplied and which allows rapid system start and reliable operation under all temperature conditions which can be expected in the vehicle.
At least one slot for memory expansions which also retain the memory content when no power is supplied (FLASH memory) allows the map data required for navigation to be stored and quickly interchanged.
A data interface is used alternatively for loading new map data into the computer.
An incorporated storage battery or another mobile power supply allows the user to use the appliance outside of the vehicle too, for example in order to plan routes in one's own time at home or at work or to be provided with a reminder about timely departure by an alarm.

Additional advantages are obtained when the appliance also has the following properties:
Ability to be operated using a touch-sensitive screen allows very rapid operation even of complex menu structures for program execution.
A transmission and reception unit for mobile radio allows the appliance to be used for telephony too. In this case, the dialing operation is performed using a touch sensitive screen or using keys or by means of voice signals.
Permanently installed software programs for personnel task, appointment and e-mail management allow the use of the personal stock of addresses for rapid input of journey destinations, for example. Departure times can be integrated into the appointments diary and can trigger the alarms for timely start of the journey on the basis of journey route and traffic situation.
Expansion slots for memory expansions whose interface also allows the inclusion of plug-in cards for other functions allow additional input/output appliances with reception elements (2, 24, 48) to be connected.

The embodiment also provides for a reception unit (1) to be integrated into the housing of the computer (5). Provision is made for this and afresh for reception elements (2) for traffic information and also combinations thereof with reception elements for position (24) or acceleration (48) or position and acceleration.

In the reception element (2), the broadcast radio signal from an antenna (28) is received using a broadcast radio receiver (34). A decoder (35) is used to obtain the digital traffic information and to forward it via a digital interface (37) to an interface (50) which is in the form of a computer-internal interface which cannot be accessed from the outside. Its design as a computer-internal interface means that this is of much simpler design than is possible in the case of external interfaces. No plug contacts are required, the user does not need to concern himself with the interfacing, the arrangement takes up less space and none of the scarce slots are used. Ultimately, the number of possible sources of error during application and production is also reduced. It is possible to integrate reception elements (2, 24, 48) into the housing of the computer (5) very extensively. The reception elements can even be integrated into the motherboard of the computer (5). The position information required for navigation is, as one alternative, detected by means of a position information receiver (16) coupled to the computer (5) externally by means of the interface (15). This affords the advantage of the position signal reception antenna (26) being able to be positioned for good reception. A particularly compact design is achieved by integrating the reception antenna for position information (24) directly into the housing of the computer (5). The same also applies to a receiver for position information which can be used to improve position finding when there is an inadequate GPS signal, as is the case when driving through tunnels, for example.

One particular advantage in relation to the possibility of retrofitting in vehicles is a combination which integrates not only a position information receiver (24) but also reception elements (48) with an acceleration sensor into the computer. This allows the current position to be calculated when position signal reception is interrupted. To this end, the changes in movement which are detected using an acceleration sensor are taken into account, on the basis of the last known movement vector, with the current section of road which is to be covered, and the vehicle position is inferred from this. The particular advantage of this embodiment is the ability to use this computer for a wide variety of personal uses and additionally the ability to use it for vehicle navigation.

Another embodiment comprises the combination of a reception unit (1) with a vehicle broadcast radio receiver (9) or multimedia appliance for broadcast radio reception via loudspeakers (43) or headphones. In this case, the function of elements such as a processor (3) or memory (14) can be provided partly for the vehicle broadcast radio receiver (9) and the reception unit (1) together, so that the processor (3) and the memory (14) no longer need to be provided more than once. To this end, all the elements required for operation, that is to say those of the broadcast radio receiver for loudspeaker output and the elements for receiving navigation information, are accommodated in one housing. Alternatively, a modular design also makes sense, in which slots are provided in the broadcast radio receiver's housing for retrofitting reception elements (2, 24, 48), individually or in combination with one another, for a full reception unit (1) or for an interface (4), which do not need to be accommodated in full in the housing of the vehicle broadcast radio receiver (9).

Advantages are obtained here through the simple access to the power supply and to the broadcast radio antenna signal line (12) for supplying the reception element (2) with broadcast radio signals. The further combination with reception elements (24) for position signals and (48) for acceleration values gives rise to the practical possibility of also transferring these data via the same connection to the computer (5), via the interfaces (4) and (7) and using the already described transmission protocol with a checking option for various reception elements for navigation data.

This embodiment is distinguished by particularly simple accessibility of the power supply and antenna signal. Similarly, for the case of replacing the existing vehicle broadcast radio receiver (9), there is the option of very simple retrofitting with optimum reception properties, since only customary vehicle components are used which are accommodated in the standard installation slot for broadcast radio receivers in the dashboard region of the vehicle.

Since broadcast radio receivers often provide a large number of further multimedia functions in addition to broadcast radio reception and in may vehicles are not fitted permanently, for example for reasons of theft prevention, it is likewise possible to combine them with removable multimedia units providing a broadcast radio reception function via loudspeakers or headphones.

For the purpose of receiving and transmitting various information from the reception unit (1) to the computer (5), a special method is used. Implementing this method requires a program sequence both in the computer (5) and in the computer (20). To this end, the traffic information is buffered in a memory (14) and is held for retrieval by the computer (5). As soon as the computer (5) establishes a need for new data, e.g. for position data in the form of GPS data, it sends an appropriate request via the interface (4) to the computer (20). The computer (20) responds to this request by sending the relevant data to the interface (4) in the opposite direction. In this way, data from all the included reception elements (2, 24, 48) can be read into the computer (5) under the need-dependent control of the computer (5) via a single interface (4) on the basis of need.

To buffer the data arriving on the reception elements (2, 24, 48) in the meantime, it is possible to select between two different types of management forms for the buffer store in the memory (14) in the reception unit (1).

Particular advantages are achieved when using a LIFO (Last In First Out) buffer, which is filled with constantly updated traffic information and is read only to the extent that transmission time or memory space suffice. In the event of an overflow or insufficiently fast request, earlier data may be lost in the process. This memory organization ensures that currently received information is preferred over earlier information if the data cannot be transmitted to the computer (5) in full. Since, by way of example, TMC transmits data redundantly and repetitively, “lost” data can be tolerated in this case.

Since the request via the interfaces (4) and (7) or (15) can be made much more quickly than reception via the reception unit (2) can take place, this allows much faster availability of the traffic information to be achieved after the computer (5) is started up.

On the other hand, the advantage of an FIFO (First In First Out) buffer is that no information is lost once it has been stored therein. If the buffer store overflows relatively often, that is to say has relatively small proportions in relation to the volume of data which is to be stored, the advantages of the LIFO memory predominate, since the current information is therefore preferred. The buffer store can be termed relatively small if it holds fewer than ten messages.

So that, when it has been turned on, and independently of the computer (5), the reception unit (1) is immediately able to use a suitable reception frequency, the computer (20) or the computer (5) generates a list of receivable frequencies with criteria for describing the respective reception quality and other properties, e.g. whether the transmitter transmits traffic information. One way of obtaining this information is to check the receivable frequencies for these properties and to enter them into a list. This list also records the frequencies which have already been used successfully. Another particular advantage in this case is storage of the geocoordinates associated with the respective reception parameters, in order to achieve a physical association with the respective suitable reception frequencies. This later allows the search for suitable transmitters to be concentrated on reception frequencies which have also produced good results previously just in physical proximity to the current position. This list should also be maintained when the power supply is interrupted so that information relating to such frequencies which are suitable for reception of traffic information are immediately available after the reception unit (1) is turned on. If the list is stored and kept available in the computer (20) then the reception unit (1) is able to quickly attain a ready to receive state for traffic messages independently of any connection to the computer (5). The list of reception frequencies can either be stored in the computer (5) or in the computer (20) or else in both in a memory which retains its content when the reception unit is turned off. This is done using storage-battery-buffered RAM memory or FLASH memory, for example. If FLASH memory is used then it must be ensured that the list is updated only at relatively long time intervals. To this end, the values relating to reception quality and usability which are ascertained at the individual reception frequencies are averaged only over relatively long periods of time with the associated constraints in order to store only stable values. Excessively frequent updating of the data would otherwise exhaust the limited number of possible storage cycles too early. To guarantee a life of 20 years, for example, it must be ensured that no more than 10 000 write operations (the maximum number of memory cycles associated with the memory used) take place in such a period. An improvement in the utilization of the stored information for the transmitter search can be achieved by additionally storing geocoordinates in the transmitter list at the same time, which later allow the reception frequencies which are most suitable for a location coordinate to be obtained from the transmitter list. Another improvement is to store an identification code associated with the transmitted program in the list at the same time in order to tell from this whether the expected transmission station can actually be received on a transmission frequency. The identification code used may be the PI (Program Identifier) code transmitted by RDS, for example.

Additions to the list of suitable transmitters are achieved using a search method in which the frequencies are scanned quickly and are checked for usability for receiving traffic messages until a suitable transmitter has been found. The frequency of the suitable transmitter is entered into the list of usable frequencies. As soon as all the frequencies in the available frequency band have been scanned for a particular time, the frequency with digital traffic information and the best reception properties from the list is set as the reception frequency of the reception element (2). In addition, even with good reception, the frequency is changed at relatively long time intervals of several minutes in order to test whether the changed vehicle position means that more suitable transmitters are available in the meantime which have better reception properties or transmit traffic information from a different coverage area. If another suitable transmitter is found then the traffic information from this transmitter is received for a prescribed time and then there is a switch back to the previous transmitter or to a new search. If a new suitable transmitter is not found during a search then the last frequency known to be usable is set again. If this does not give a result either, the penultimate one which can be used and, in this order, the list of usable frequencies are checked. The usability of the respective frequencies is stored with quality criteria in the list of transmitters. A particular advantage is the additional storage of the associated geocoordinates. This subsequently allows an accelerated test pass, since first of all the frequencies marked as usable are set, for which the probability of good reception is greater than when scanning all available frequencies. If geocoordinates are available for the stored reception frequencies and for the current position then the search for suitable frequencies is first of all concentrated on the known frequencies at a limited physical distance. The system equipped in this manner is therefore able to store the empirical values for the optimum reception conditions on roads which have already been covered, so as later to check the appropriate frequencies for usability more quickly.

Besides the transmission of traffic, position and acceleration information, provision is also made for further data to be transmitted, e.g. from a reception element (49) via the interface (4) of the processor-controlled reception unit (1) or from other information providers (18), e.g. from the on-board computer or from other sensors installed in the vehicle, via the interface (19) to the computer (5).

To allow the components described to be used for different instances, it is advantageous for them sometimes not to be mechanically connected to one another permanently but rather to make them combinable with one another on the basis of application. By way of example, this modular design makes sense in order to be able to use the reception unit (1) both for permanent installation in the antenna signal line and for detachable fixing in different vehicles. To this end, a module, for example, comprising solar cells and a storage batter and also a charging circuit for controlling the charge state of the storage battery can be combined detachably with the transmission and reception unit (1). This embodiment is illustrated in FIG. 5. Another embodiment comprises modular integration of the coupling element (13), which is used only when simple feeding of the supply voltage into the antenna signal line via a coupling element (11) is possible or already provided.

To prevent the apparatuses described from being used in a form which is not authorized by the manufacturer, a protection apparatus is provided. In this regard, before data communication is started, it is necessary to check key combinations which have been added in the form of data to the computers (5) and (20) or to the undetachable peripheral area permanently and unalterably during manufacture. Only when it is established that these are authorized key combinations is communication enabled. By way of example, the key combinations are authorized by means of registration and generation of an enable key by the manufacturer which allows a connection to be set up only in combination with the key combinations impressed during manufacture.

The described arrangements comprising a reception unit (1) with reception elements (2) for traffic information allow a method for combining the position data required for vehicle navigation with traffic information. This makes it possible to achieve an improvement in the navigation by including the traffic situation and hence the limitation to the speed of travel on particular routes or even closure of particular routes in the route planning.

The method described below results in optimization of the journey route by taking account of the traffic situation. To this end, the best journey route is first of all calculated and the traffic information is used to check whether there are traffic disruptions on the ascertained route. If disruptions can be found here, a reduced speed of travel which can be ascribed to the reported traffic disruptions is fixed for the disrupted regions. This now involves a new route being calculated and a check being performed to determine whether there are traffic disruptions on the newly calculated route, until it is not possible to achieve any further improvement in routing. As an alternative to this iterative method, it is also possible to take account of the traffic disruptions on all suitable routes in a very first computation step. This process is more memory-intensive than the one described above.

When using small portable computers (5) for navigation, when traffic information is available, another method opens up the opportunity—on the basis of the distance to be covered and the desired time in which the distance needs to have been covered—to ascertain the optimum departure time. This may also have a lead time added to it. This allows ascertainment of an appropriate alarm time at which the computer (5), which does not need to be in the vehicle at this time, outputs a signal which provides a reminder about the imminent start of the journey. The traffic information used for the calculation is received via a reception element (2). If the reception element (2) for traffic information is not available outside of the vehicle, provision is made for traffic information about Internet access by the computer (5) to be obtained from an Internet server. This method is particularly advantageous if the computer (5) used is so easily transportable that the user can take it with him from the vehicle, so that he registers the alarm message even when he is not in the vehicle.

Alternatively, the alarm signal from the reception unit (1) can also be sent as a short message to the user's mobile telephone using a coupled mobile radio transmission unit, so that the user is reminded of the start of the journey as soon as this is appropriate on the basis of the planned journey distance and traffic situation. In this case, the computer (5) and the reception unit (1) can remain in the vehicle.

### FIGURES

FIG. 1a: The computer (5), which has at least one processor (8), a memory (6) and a user interface (22), is used as a platform for navigation software which takes the navigation data, such as position data, acceleration data and traffic data and possibly other data, as a basis for performing routing calculations and for outputting appropriate driving instructions. In addition, the computer (5) has a built-in power supply, a memory (45), which is partly in the form of a solid state memory (47) which is nonvolatile when the power drops out, and at least one interface (7, 15) which may be in the form of an interface for wireless or wired connections. These interfaces can be used to connect external position receivers (16) or other information providers (18) via interfaces (17, 19). The reception unit (1) associated with the invention supplies the computer (5) with navigation data in the advantageous manner already described and is used to largely replace the elements of position receiver (16) and information provider (18) with the interfaces (17, 19) in order to get around the interface and installation problems already described.

FIG. 1b shows a reception unit (1). The broadcast radio signal received via the vehicle broadcast radio antenna (23) is fed into the reception element (2) from the antenna signal line (12) by means of the coupling element (21) or by means of a separate antenna input (28). When the reception unit (1) is designed for traffic information reception, a reception element (2) is connected to one of the interfaces (36) of the computer (20) via an interface (37).

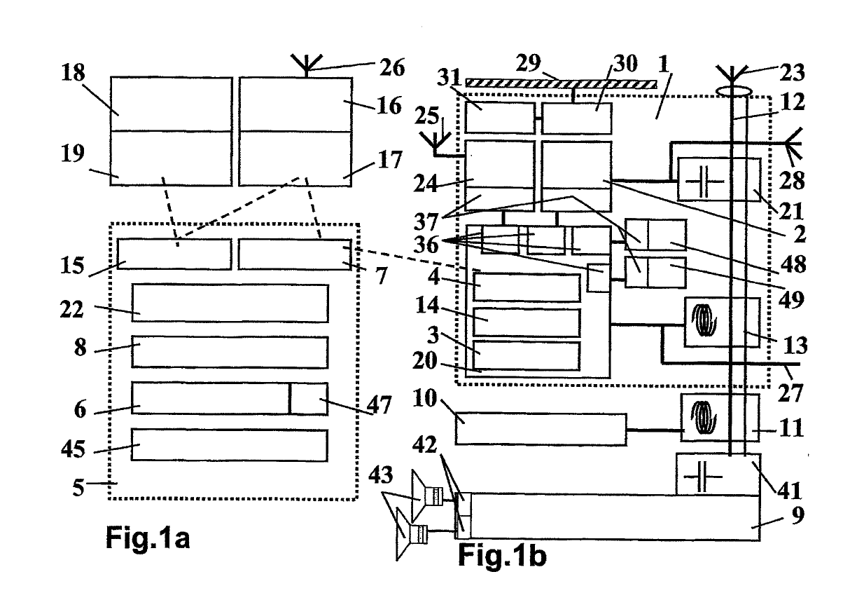

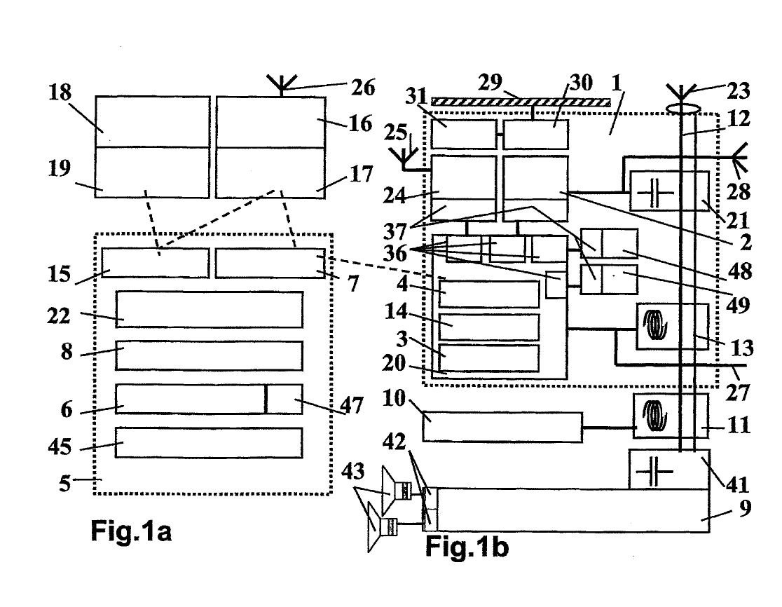

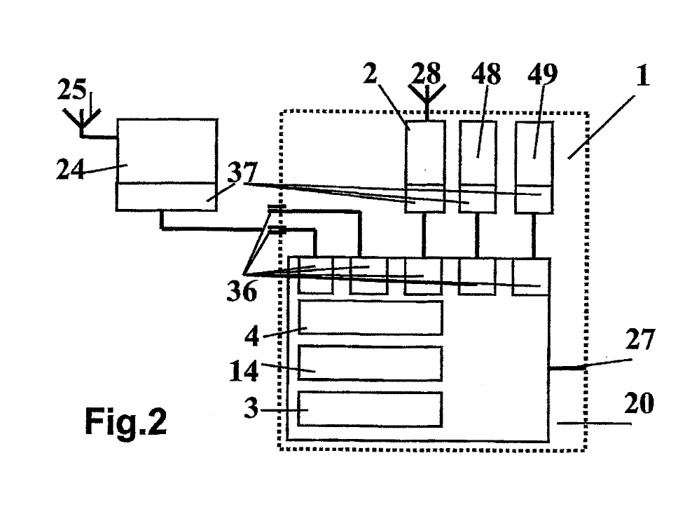

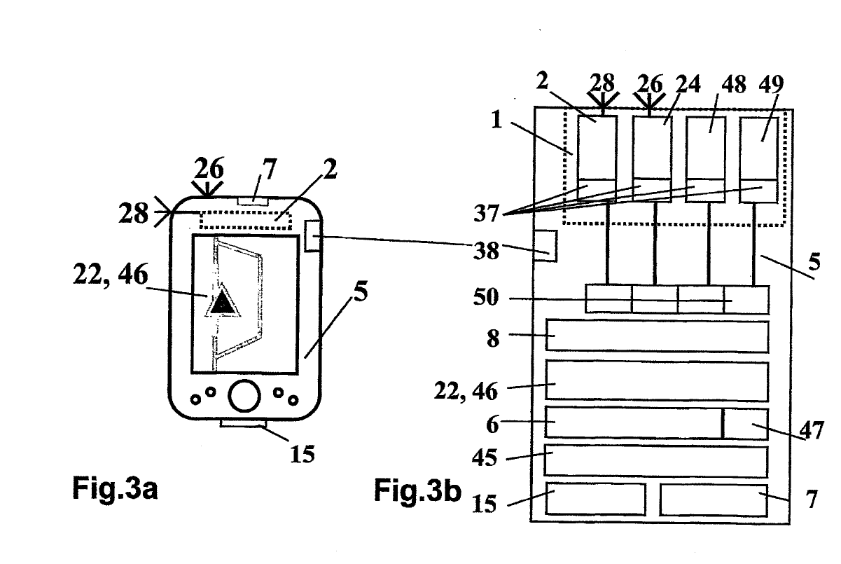

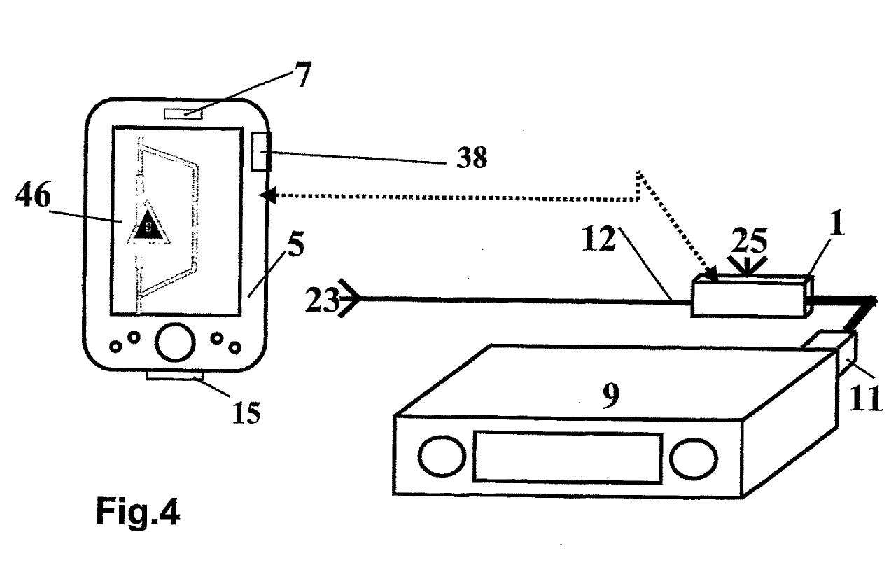

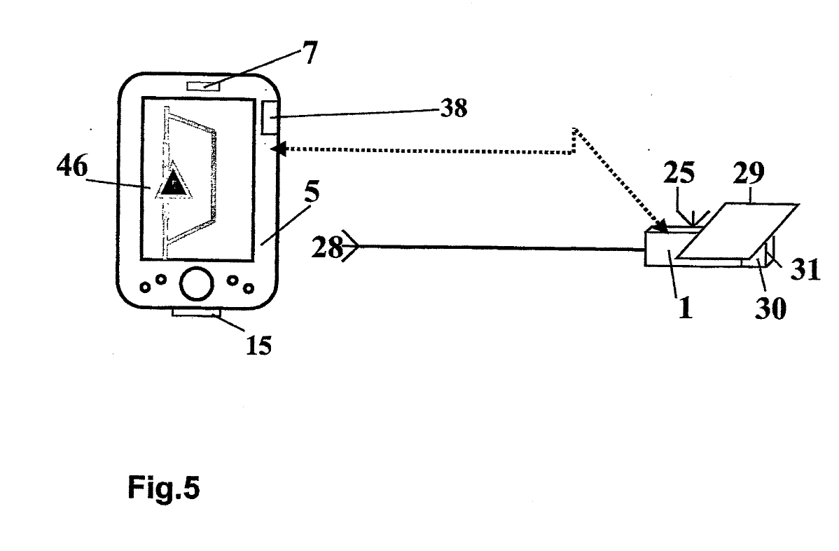

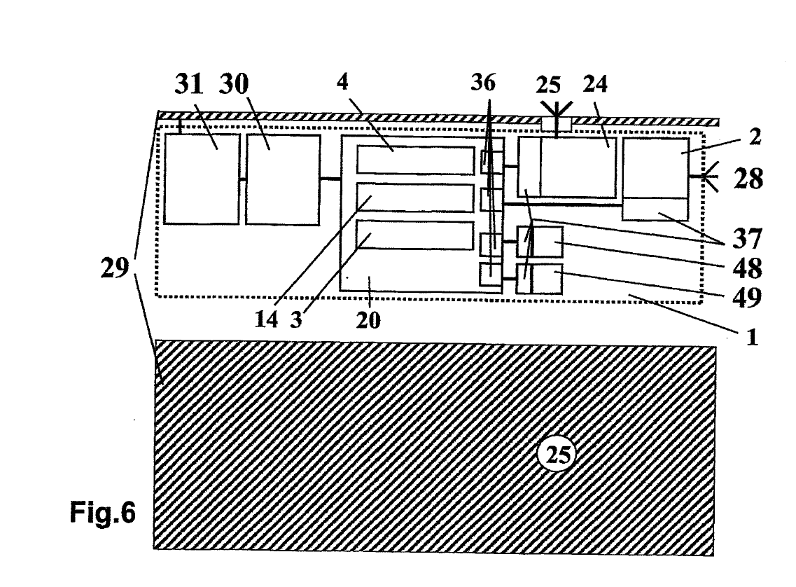

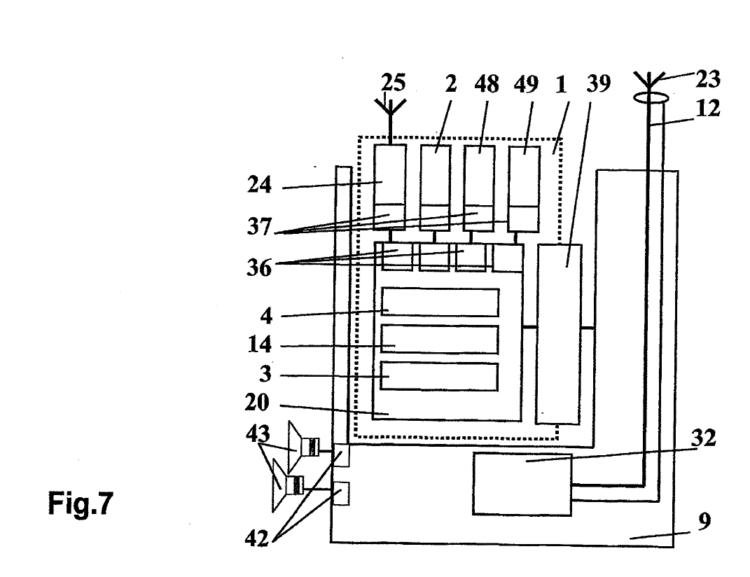

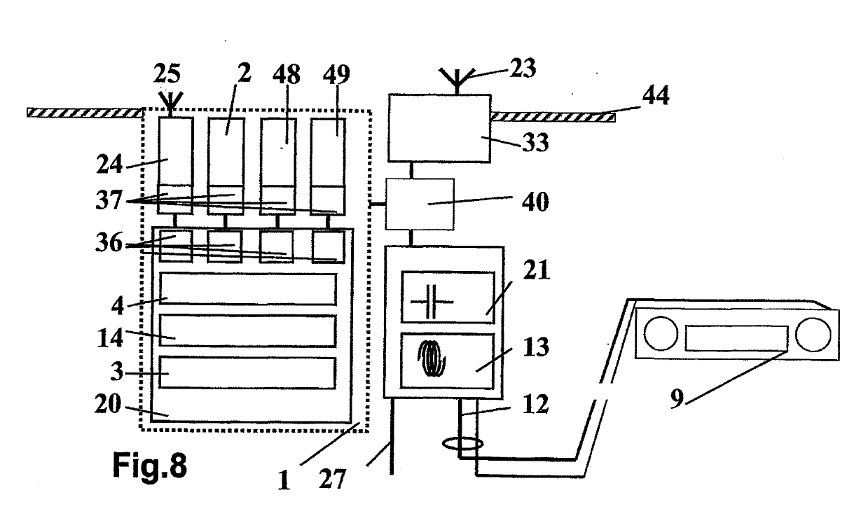

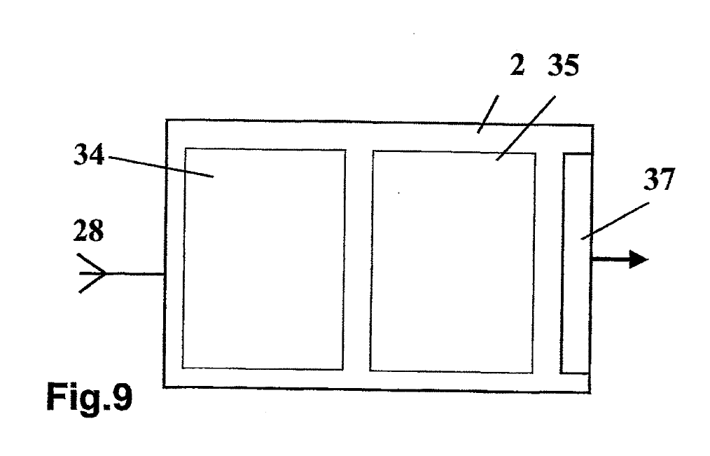

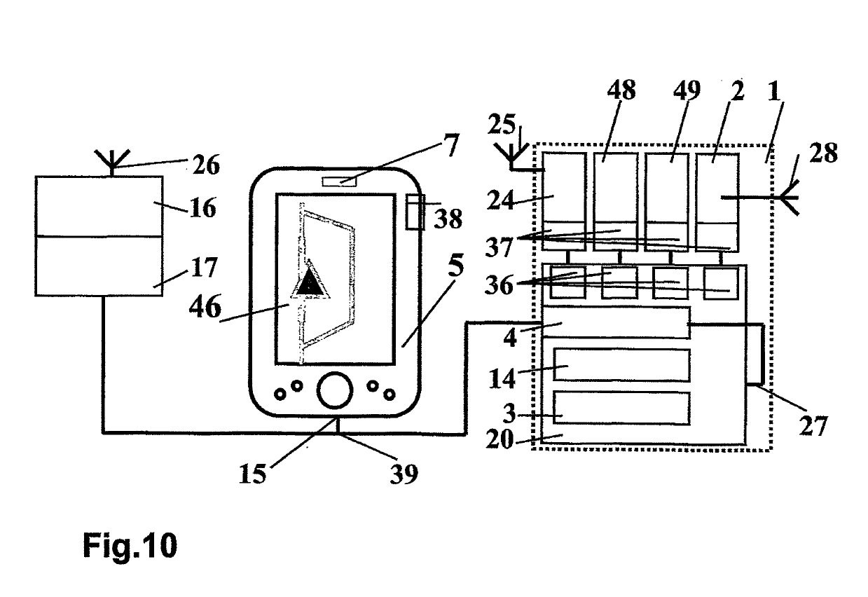

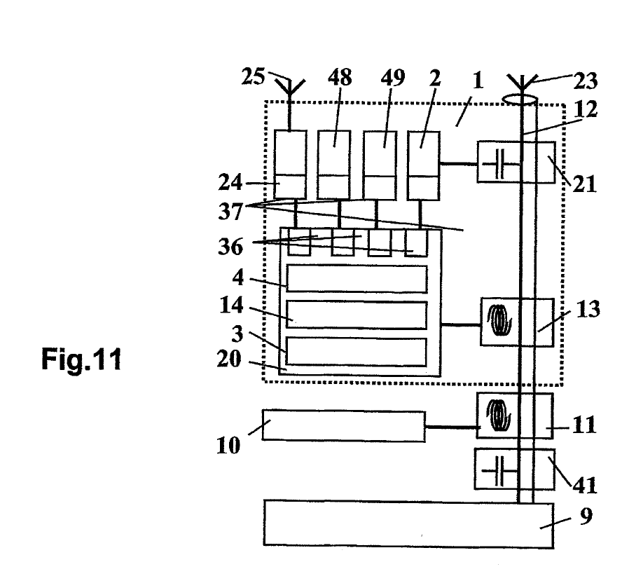

From the broadcast radio signal, the reception element (2) obtains digital raw data which are processed in the computer (20) and are forwarded to the interface (4). If the reception element (2) is designed for analog broadcast radio, for example, then it contains, as FIG. 9 shows, an FM receiver (34), often also called a tuner, and an RDS decoder (35). The FM receiver either has an antenna (28) connected to it directly or has the vehicle antenna signal line (12) connected to it via the coupling element (21).

When a position information receiver (24) is provided as equipment, e.g. a GPS receiver which receives signals via the antenna (25), the position data are routed to the computer (20) via an interface (37) and one of the interfaces (36). Position information receivers (24), particularly in the form of GPS receivers, are designed such that they automatically perform all computation operations which are required in order to calculate the current length, width and height coordinates from received satellite signals from the global positioning system, and forward them to the receiving computer (5) using a standardized protocol.

When a reception element (48) is provided as equipment, this is also connected to the computer (20) via interfaces (37) and (36). When the mobile computer (5) is designed to have a reception element (48) integrated directly within the computer, said reception element is connected via the interface (50) inside the computer. By way of example, in the case of the reception element (48), this sensor may be an acceleration sensor which detects accelerations in translational or rotational form for one or more axles. In this case, the data are evaluated in order to assist the position finding by the position finding receiver, e.g. when it has no reception.

To this end, the changes in direction of travel and speed are detected and are forwarded to the computer (5), which therefore becomes able to calculate changes in position from the last known coordinates and the last known speed vector by taking account of the translational or rotational acceleration values.

The interfaces (36) may be designed differently for the reception elements (2), (24) and (48). Thus, the interface (36) may be found in multiple instances and in different embodiments in the computer (20) or (5). The interfaces (37) need to be coordinated with their respective corresponding interfaces (36).

The computer (20) contains at least one processor (3), a memory (14) and an interface (4). The computer (20) provides the data for retrieval via the interface (4).

The interface (4) may be in the form of a wired interface or in the form of a wireless interface. The wired interface (4) used may be a USB connection. A suitable wireless interface is either an optical link, e.g. IRDA (infrared), or a radio link. When radio transmission is used, the transmission techniques already described need to be applied for frequency selection, transmission power etc.

The information can be transmitted via the interfaces (4) and (7) using the radio transmission methods already described, such as Bluetooth, ZigBee, WLAN or USB, WUSB, UWB, or else the widespread serial interface for point-to-point connections.

In addition, the methods already described for the computer (5) to request traffic information or position information can be used for the transmission protocol via the interface (4).

The digital information transmitted by the interface (4) and status messages from the reception elements (2, 24, 48), such as about field strength and reception quality or the number of satellites received, is/are received by the interface (7) in the computer (5). Conversely, the computer (5) is also able to control the reception response of the reception elements, e.g. in the case of the reception element (2), via the interfaces (7) and (4). By way of example, provision is made for reception frequencies to be set, for a transmitter search to be started or for reception criteria to be transmitted for the transmitter selection. Similarly, provision is made for the response of the entire reception unit (1) to be designed to be controllable via the interface (4).

The power supply for the reception unit (1) is fed either by means of a direct power supply (27) or by means of a coupling element (13) from the vehicle antenna signal line or by means of solar cells (29) buffered by a storage battery (30).

When power is supplied by means of the coupling element (13), the voltage across a coupling element (11) is fed in by the power supply (10) within the vehicle broadcast radio receiver (9) or else outside of it. In one embodiment, the entire arrangement (1) is designed such that there is space for it in an adapter plug, figure (4), for interposition in the antenna signal line (12) and hence it can be installed very easily.

Alternatively, the supply voltage for the reception unit (1) is obtained from solar cells (29). These first of all feed a charging circuit (31). This charging circuit (31) monitors the voltage in a storage battery (30) and charges the latter when its voltage is below a limit value and there is sufficient light hitting the solar cells. To save power, a logic section may also be provided here which puts the entire unit into a power-saving state in which the reception activities are reduced to short reception intervals at relatively long intervals of time as soon as no further data have been requested for a particular period.

The supply of power via a coupling element (13) or via solar cells (29) makes sense for reception units (1) with reception elements (2) for traffic information, (24) for position information and (48) for acceleration information individually or in combination with one another.

Besides the advantages of the individual problem solutions, further advantageous embodiments are obtained by combining the elements of the invention which are described.

Particularly advantageous combinations are cited below:
a processor-controlled reception unit (1) as a traffic radio receiver with a radio interface (4) to a computer (5) with a power supply via the antenna line, integrated into the vehicle broadcast radio receiver or into the antenna base,
a processor-controlled reception unit (1) equipped with interfaces (36) for further reception elements and use of the method described for serial transmission of the data from a plurality of reception elements via a transmission channel,
a processor-controlled reception unit (1) with a position information receiver and a radio interface (4) to a computer (5), a solar power supply, combined with further reception elements, e.g. for acceleration or traffic information,
a processor-controlled reception unit (1) with a reception element for traffic information and/or acceleration, equipped with an interface for a star topology for the simple, primarily cable-based connection of a plurality of reception elements to a computer (5),
a processor-controlled reception unit (1) with a position receiver and an acceleration sensor or in combination with a traffic information receiver in a handy portable and universally usable personal small computer with a dynamic navigation program,
a combination is said embodiments with methods for separate startup and storage of the reception frequencies for traffic information.

FIGS. 2 to 11 show examples of essential basic forms for implementing the invention.

FIG. 2 shows the embodiment of a reception unit (1) for traffic information which transmits the received data via an interface (4) in wireless form to a computer (5) for further processing. The interface (4) uses a radio transmission method of the type already described or an infrared transmission method such as IRDA. In addition, besides reception elements (2) for traffic information, there may be further reception elements (24) with an antenna (25), e.g. for ascertaining position data, or reception elements (48), e.g. with a sensor system for acceleration detection. Further embodiments comprise the combination of this embodiment with the embodiments already described for outputting the antenna signal from the vehicle antenna signal line (12), for outputting the power supply from the vehicle antenna signal line (12) or for supplying power to the reception unit (1) by means of solar cells.

In another embodiment, the interface (4) is not in wireless form but rather uses a serial interface, where the combination with a further interface (36), which is in the form of a serial interface for point-to-point connections, allows a position information receiver to be connected and allows the data from the traffic information receiver and from the position information receiver to be requested. To transmit the data via an interface (4), the data transmission method described is used, in which the computer (5) controls which reception element (2, 24, 48, 49) transmits data.

FIG. 3 shows an embodiment in which the reception unit (1) is combined with a computer (5) in a unit, for which purpose the reception unit does not occupy every slot and does not occupy an externally accessible interface of the computer (5). In this embodiment, the computer (5) comprises at least a processor (8), a memory (6) and a user interface (22). Advantages are obtained by virtue of no further cables being required in addition to an antenna connection. In this case, the reception element (2) is integrated into the housing which contains the computer (5) which is equipped with the mobility properties defined further above (weight, size, interfaces, mobile power supply etc.) by means of the antenna connection (28). The coupling to the processor (8) is provided by means of an interface (37) on the reception unit and an internal interface (50) in the computer (5), and the coupling should be designed so as not to be able to be detached without tools. The version as an I2C interface is suitable for this, for example. The invention provides for further externally accessible interfaces (7) and (15) or a slot for memory expansions (38) on the computer (5) not to be used by the interface (37) of the reception element (2).

The embodiment integrated with the mobile computer (5) is suitable both for integration of a reception element (2) for traffic information and for combinations of reception elements (24) for position detection and (48) for acceleration detection and for combinations with the reception elements (2), (24) and (48).

FIG. 4 shows an overview of the elements of the invention which are visible to the user in the embodiment as an adapter plug for the antenna signal line (12) of the vehicle broadcast radio receiver (9). In this context, the reception unit (1) may also be situated below the dashboard paneling, even when a satellite-assisted position receiver and a built-in satellite antenna (25) are provided as equipment, since the satellite signal can also be received through the customary dashboard panelings. If a reception element (48) with an acceleration sensor is also integrated into the reception unit (1) then correct orientation relative to the vehicle needs to be ensured when installing in the vehicle in order to detect the acceleration values in the direction of travel and downward exactly.

FIGS. 5 and 6 show the combination of the transmission and reception unit (1) with a solar module which comprises solar cells (29), a storage battery (30) for bridging phases when no light is supplied and a charging circuit (31) for the storage battery.

In this context, FIG. 5 shows only the elements which are visible to the user. On account of the fact that it is simple to install, this arrangement is intended for provisional use in vehicles, e.g. when it is to be used in different vehicles. For operation, this embodiment merely needs to be mounted at an appropriate point in the vehicle, e.g. on the windscreen or rear screen. No wiring to other appliances or power sources is required. The necessary reception field strength for satellite and traffic radio and also the incidents of light for the power supply are usually sufficient at these locations. Embodiments with reception elements (2), (24) and (48) individually or in combination are appropriate.

FIG. 6 shows the design of a solar-powered reception unit (1) for position, acceleration and traffic information and possible addition of reception elements (49). The antenna (28) is used to receive broadcast radio signals and to obtain digital traffic information therefrom using the reception element (2). Alternatively or in combination with this, satellite signals are conditioned in the reception element (24) via the antenna (25). It is also advantageous for a further reception element (48), e.g. an acceleration sensor, to be provided as equipment. The respectively obtained data are forwarded to an interface (36) of the microcomputer (20) via a respective interface (37). When the design is a pure position receiver, only the reception element (24) and the antenna (25) are accordingly provided, and when the design is a pure traffic information receiver only the reception element (2) with the antenna (28) is provided. The microcomputer (20) performs preprocessing and provision for transmission via an interface (4) to the computer (5), which interface is of wireless design. The transmission method used for this is IRDA or one of the shorthaul multifrequency radio methods with limited transmission power already described. The voltage generated by the solar cells (29) is supplied via a charging circuit (31) which in turn controls the charging process for the storage battery (30). The circuit is a power-saving design by virtue of a logic section, for example, in the computer (20) checking whether data are being requested by the computer (5). Otherwise, the entire circuit is switched to a power-saving state in which traffic information is now received only at relatively long intervals and a check is performed to determine whether there are data requests from the computer (5).

When the satellite-assisted position receiver is combined with solar modules, a particularly compact design can be achieved since both components require a similar orientation to the open sky. These components are therefore arranged very close to one another and relatively solidly with respect to one another. With standard solar cells, a power yield is achieved which allows the operation of a reception unit (1) with an active solar cell area corresponding approximately to the housing surface of the reception unit (1) when irradiated by the sun. The storage battery (30) in this combination is designed such that it bridges approximately 10-hour operation without irradiation by the sun and thus allows daily journeys in the dark of approximately 3-4 hours and in exceptional cases even more if this has a corresponding daily average solar irradiation of similar length.

FIG. 7 shows an embodiment as a combination of the reception unit (1) with a vehicle broadcast radio receiver (9). In this context, the computer (20) is enclosed completely by the housing of a vehicle broadcast radio receiver (9) which, besides reproducing broadcast radio programs received with the reception element (32) on loudspeakers (43), which are coupled by means of loudspeaker outputs (42), can also perform multimedia functions with other functions. The computer (20) contains a processor (3) and a memory (14), which also perform control functions within the broadcast radio receiver (9). The interface (4), which in this embodiment is preferably in the form of a shorthaul multifrequency radio interface with the special properties already described, is used to transmit the navigation data to the computer (5). The reception element (2) for traffic information and—depending on the embodiment—the reception element (24) for position information, the reception element (48) with a sensor, which detects accelerations, and further reception elements (49) are connected to interfaces (36) of the computer (20) via interfaces (37).

The embodiment of integration of the reception unit (1) with a vehicle broadcast radio receiver is provided for position receivers, traffic information receivers and combined receivers which provide both or more information. Combined receivers have the reception elements (2), (24) and possibly also (48) and (49). Depending on assumptions and on the receivers which are already present, all combinations with further reception elements are also appropriate, however.

FIG. 8 shows a combination of the reception unit (1) with an antenna amplifier (33) in the region of the vehicle's external antenna (23) which is beneficial for receiving the satellite signal. The interface (4), which is preferably in the form of a radio interface, can be arranged inside the bodywork panel (44) so as not to impair the radio transmission to the computer (5). In this embodiment, the computer (20) with the interfaces (4) and (36) is fitted close to the antenna amplifier, ideally in the same housing. The coupling between the reception element (1), the antenna amplifier (33) or the antenna signal line (12) and the continuation of the antenna signal line in the direction of the vehicle broadcast radio receiver (9) is provided by means of an interface (40). This interface is used to provide the reception unit (1) both with the antenna signal and with the supply voltage either from the antenna signal line (12) or via a separate power supply cable (27). This allows a joint power supply for the reception unit (1) with the antenna amplifier (33) and also output of the antenna signal from the vehicle antenna signal line (12). The supply voltage is supplied either directly by the cable (27) or by means of a coupling element (13), with antenna signal coupling being provided by means of a coupling element (21) in the latter case.

The embodiment based on a combination of the reception unit (1) with the antenna amplifier is provided for position receivers, traffic information receivers and combined receivers providing both information. In the case of combined receivers, all combinations with all reception elements (2), (24) and (48) or else (49) or subsets of these are advantageous.

FIG. 9 shows the design of a reception element (2) for receiving traffic information using the example of reception via analog broadcast radio signals by decoding data from the radio data system (RDS). In this case, the broadcast radio signal is received by the receiver (34), in this case called a tuner, via the antenna (28) and the RDS data stream is obtained from the received signal using a decoder (35). These RDS data are provided for the further processing already described via the interface (37).

FIG. 10 shows the connection of a reception unit (1) to a PDA via a wired interface (15). When this wired interface (15) is in the form of a bus system with a star architecture (39) and a star point for the computer (5), it is possible to connect further appliances to the same interface (15). Besides the reception element (2) for traffic information, the reception unit (1) can also contain reception elements (24) for position information and (48) for acceleration information. In addition, a position information receiver (16) or a reception element (48) for acceleration information may also be connected to a possibly also wireless interface (7) of the PDA via another interface (17). Simultaneous coupling to the interface (15) is only possible with a bus system. A bus system with a ring structure would increase the wiring complexity upon retrospective installation and is therefore less suitable. The reception elements (2), (24) and (48) are coupled to the computer (20) by means of interfaces (37) and (36). For the power supply (27), the supply voltage is output from the data transmission cable between the interface (15) and the interface (4) which (cable) provides this voltage.

FIG. 11 shows the embodiment of a reception unit (1) with supply of power via the antenna signal line (12), which is equipped with a reception element (2) for traffic information and with a reception element (24) for position information. Embodiments with just one of the reception elements are likewise appropriate, as is equipment with reception elements (48) and (49). In this case, the power supply for the reception unit (1) is supplied via the coupling element (13). If the supply voltage is not already available on the antenna signal line (12) then it needs to be fed into the antenna signal line (12) via a coupling element (11). An embodiment in which the antenna signal for broadcast radio reception is supplied to the reception element (2) from the antenna signal line (12) via a coupling element (21) allows dual use of the antenna signal line (12) for providing the antenna signal and the supply voltage. DC decoupling for the antenna input is provided in customary broadcast radio receivers. If this is not the case then the antenna signal line (12) is coupled to the vehicle broadcast radio receiver via a coupling element (41) which only allows radio-frequency signals to pass.

### LIST OF REFERENCE SYMBOLS

1 Reception unit
2 Reception element for traffic information
3 Processor
4 Interface
5 Computer
6 Memory
7 Interface
8 Processor
9 Vehicle broadcast radio receiver
10 Power supply
11 Coupling element
12 Antenna signal line
13 Coupling element
14 Memory
15 Interface
16 Position receiver
17 Interface
18 Information provider
19 Interface
20 Computer
21 Coupling element
22 User interface
23 Vehicle broadcast radio antenna
24 Reception element for position information
25 Position signal reception antenna
26 Position signal reception antenna
27 Power supply cable
28 Antenna
29 Solar cells
30 Accumulator
31 Storage battery
32 Reception element for broadcast radio reception
33 Antenna amplifier
34 Receiver/tuner
35 RDS decoder
36 Interface
37 Interface
38 Slot for memory expansions
39 Bus system with star architecture
40 Interface
41 Coupling element
42 Loudspeaker outputs
43 Loudspeakers
44 Bodywork panel
45 Power supply
46 Color screen user interface
47 Solid state memory
48 Reception element for acceleration information
49 Additional reception element
50 Internal interface

1. A processor-controlled reception unit for navigation data, containing at least one processor, at least one memory unit, at least one interface for transmitting navigation data to a computer, and containing altogether at least one reception element connected via an interface, characterized in that
a) the reception element is used to receive broadcast radio signals and to output digitally encoded traffic information,
b) the reception element is used to detect acceleration information,
c) the interface is radio based, uses more than one frequency for transmission and the radio link has a maximum transmission power of less than 150 mW,
d) the reception unit is free of receivers for position information,
e) the reception unit can be operated without a coupled position receiver.

2. The processor-controlled reception unit for navigation data as claimed in claim 1, characterized by at least one of the following properties:
a) the reception unit is used to receive radio signals only from terrestrially broadcast transmitters,
b) the housing of the reception unit contains a power supply for temporary operation without an external power supply cable,
c) besides the digitally encoded traffic information only a selection of further digital data from the broadcast radio signal is transmitted to the computer.

3. A processor-controlled reception unit for navigation data, containing at least one processor, at least one memory unit, at least one interface for transmitting the navigation data to a computer, and at least one reception element connected via an interface, characterized in that
a) the reception element is used to receive broadcast radio signals and to output digitally encoded traffic information,
b) the reception element is used to detect acceleration information,
c) the reception element is used to detect position information,
d) the power supply for the reception unit is provided by means of solar cells and is storage battery buffered by a storage battery,
e) the interface is radio based, uses more than one frequency for transmission and the radio link has a maximum transmission power of less than 150 mW.

4. The processor-controlled reception unit as claimed in claim 3, characterized by at least one of the following properties:
a) the solar cells are connected to the housing of the reception unit,
b) the solar cells can be connected to the housing of the reception unit to form a unit,
c) the reception antenna of a reception element incorporated in the reception unit for position information is no further than 20 cm away from the solar cells for the power supply.

5.-22. (canceled)

23. The processor-controlled reception unit for navigation data as claimed in claim 1, characterized in that the interface is a radio interface which has at least one of the following properties:
a) it is bidirectional and transmits data in both directions,
b) it uses more than one frequency for transmission,
c) the transmission frequency is automatically changed during transmission,
d) the transmission power is less than 101 mW,
e) the transmission power is less than 51 mW,
f) it uses a frequency range from 860 MHz to 920 MHz for transmission,
g) it uses a frequency range from 2.3 GHz to 2.5 GHz for transmission,
h) it uses a frequency range from 4.7 GHz to 5.5 GHz for transmission,
i) the transmission takes place using a plurality of superimposed frequencies.

24. A processor-controlled reception unit for navigation data, containing at least one reception element, combined with a computer, containing at least one processor, at least one memory unit, at least one user interface, characterized in that
a) the reception element is arranged inside the housing of the computer,
b) the reception element receives broadcast radio signals and outputs digitally encoded traffic information,
c) the reception element is coupled to an interface inside the computer,
d) the computer contains at least one external data interface which can be reached without tools in the operating state,
e) the computer can be operated by means of a power supply located in the housing—and hence temporarily also without an external power supply,
f) the computer contains an incorporated screen, suitable for map display, as a user interface which allows color displays,
g) the computer contains a permanently incorporated solid state memory of at least 3 Mbytes which stores data without any mechanically moving parts and retains the memory content when no power is supplied,
h) the computer weighs less than 300 grams when all the parts which can be detached without tools and which are not required for the intended operation have been removed.

25. The processor-controlled reception unit for navigation data combined with a computer as claimed in claim 24, characterized in that
a) at least one reception element is included, the reception element being used to detect position information and the reception element being used to detect acceleration information using an acceleration sensor,
b) the reception element is arranged inside the housing of the computer,
c) the reception element is coupled to interfaces inside the computer,
d) the reception element does not use an externally accessible interface of the computer.

26. A processor-controlled reception unit for navigation data, containing at least one computer having at least one processor, at least one memory unit, at least one user interface and at least one reception element, arranged inside the housing of the computer, for receiving position information, characterized in that
a) at least one reception element which can be used to detect acceleration information using an acceleration sensor is arranged inside the housing of the computer,
b) the reception elements are coupled to interfaces inside the computer,
c) the computer contains at least one external data interface which can be reached without tools in the operating state,
d) the computer can be operated by means of a power supply situated in the housing—and hence temporarily also without being connected to an external power supply,
e) the computer contains an incorporated color screen, suitable for map display, as a user interface,
f) the computer contains a permanently incorporated solid state memory of at least 3 Mbytes which stores data without any mechanically moving parts and retains the memory content when no power is supplied,
g) the computer weighs less than 300 grams when all the parts which can be detached without tools and which are not required for the intended operation have been removed.

27. The processor-controlled reception unit for navigation data as claimed in one of claim 1, characterized by at least one of the following properties of the reception element:
a) the frequency of the received signal is between 1 MHz and 1.5 GHz,
b) the frequency of the received signal is between 1.5 GHz and 5.2 GHz,
c) the frequency of the received signal is between 70 MHz and 120 MHz,
d) it receives radio signals from a radio network for mobile telephones,
e) it receives terrestrially broadcast radio signals,
f) it receives satellite-broadcast radio signals,
g) it receives TMC-encoded broadcast radio signals,
h) it receives TPEG-encoded broadcast radio signals,
i) it receives digital broadcast radio signals such as DAB or DVB-T.

28. The processor-controlled reception unit for navigation data as claimed in claim 26, characterized by at least one of the following properties:
a) the reception element detects speed changes in at least one axle direction,
b) the reception element detects angular speed changes around at least one axle.

29. The processor-controlled reception unit for navigation data as claimed in claim 1, characterized in that at least one of the included reception elements is situated inside the housing of the reception unit such that it can only be detached using tools.

30. (canceled)

31. The processor-controlled reception unit for navigation data as claimed in one of claim 1, characterized in that the reception unit has at least one free interface to which further reception elements can be coupled.

32. The processor-controlled reception unit for navigation data as claimed in claim 1, characterized in that all the elements required for implementation are situated together inside one cohesive physical unit, which may also be the result of a modular design for the single components.

33.-38. (canceled)

39. The processor-controlled reception unit for navigation data as claimed in claim 26 in combination with a coupleable computer, characterized in that the coupleable computer has one or more of the following properties:
a) the computer has at least one interface for coupling to the reception unit via the interface,
b) the computer can be temporarily operated without an external power supply cable by means of a power supply which is in the housing,
c) the computer can be controlled using a touch-sensitive screen,
d) the computer weighs less than 300 grams after all the parts which can be detached without tools and which are not required for the intended operation have been removed,
e) the computer contains at least one external data interface which can be reached without tools in the operating state,
f) the computer contains an incorporated color screen, suitable for map display, as a user interface,
g) the computer contains a permanently incorporated solid state memory of at least 3 Mbytes which stores data without any mechanically moving parts and retains the memory content when no power is supplied.

40. The processor-controlled reception unit for navigation data as claimed in claim 24 in combination with a coupleable computer, characterized in that the coupleable computer has one or more of the following properties:
a) the computer contains memory-resident software programs for personal task, appointment and e-mail management,
b) the computer contains at least one interface which is in the form of a radio interface,
c) the computer can be controlled using a touch-sensitive screen,
d) the computer contains a dialing device combined with a transmission and reception unit for mobile telephony,
e) the interface of the computer which is used by the reception element is externally inaccessible,
f) the computer weighs less than 200 grams after all the parts which can be detached without tools and which are not required for the intended operation have been removed,
g) the computer can be installed in the dashboard area of motor vehicles and can be removed from the motor vehicle without the use of tools,
h) the computer contains at least one slot for memories which is externally accessible without tools and which retains the memory content even when no power is supplied,
i) the solid state memory of at least 3 Mbytes which is used in the computer is FLASH memory.

41.-42. (canceled)

43. The processor-controlled reception unit for navigation data as claimed in claim 3, characterized in that the interface is a radio interface which has at least one of the following properties:
a) it is bidirectional and transmits data in both directions,
b) it uses more than one frequency for transmission,
c) the transmission frequency is automatically changed during transmission,
d) the transmission power is less than 101 mW,
e) the transmission power is less than 51 mW,
f) it uses a frequency range from 860 MHz to 920 MHz for transmission,
g) it uses a frequency range from 2.3 GHz to 2.5 GHz for transmission,
h) it uses a frequency range from 4.7 GHz to 5.5 GHz for transmission,
i) the transmission takes place using a plurality of superimposed frequencies.

44. The processor-controlled reception unit for navigation data as claimed in claim 3, characterized by at least one of the following properties of the reception element:
a) the frequency of the received signal is between 1 MHz and 1.5 GHz,
b) the frequency of the received signal is between 1.5 GHz and 5.2 GHz,
c) the frequency of the received signal is between 70 MHz and 120 MHz,
d) it receives radio signals from a radio network for mobile telephones,
e) it receives terrestrially broadcast radio signals,
f) it receives satellite-broadcast radio signals,
g) it receives TMC-encoded broadcast radio signals,
h) it receives TPEG-encoded broadcast radio signals,
i) it receives digital broadcast radio signals such as DAB or DVB-T.

45. The processor-controlled reception unit for navigation data as claimed in claim 24, characterized by at least one of the following properties of the reception element:
a) the frequency of the received signal is between 1 MHz and 1.5 GHz,
b) the frequency of the received signal is between 1.5 GHz and 5.2 GHz,
c) the frequency of the received signal is between 70 MHz and 120 MHz,
d) it receives radio signals from a radio network for mobile telephones,
e) it receives terrestrially broadcast radio signals,
f) it receives satellite-broadcast radio signals,
g) it receives TMC-encoded broadcast radio signals,
h) it receives TPEG-encoded broadcast radio signals,
i) it receives digital broadcast radio signals such as DAB or DVB-T.

46. The processor-controlled reception unit for navigation data as claimed in claim 24, characterized in that at least one of the included reception elements is situated inside the housing of the reception unit such that it can only be detached using tools.

47. The processor-controlled reception unit for navigation data as claimed in claim 26, characterized in that at least one of the included reception elements is situated inside the housing of the reception unit such that it can only be detached using tools.

48. The processor-controlled reception unit for navigation data as claimed in claim 24, characterized in that the reception unit has at least one free interface to which further reception elements can be coupled.

49. The processor-controlled reception unit for navigation data as claimed in claim 26, characterized in that the reception unit has at least one free interface to which further reception elements can be coupled.

50. The processor-controlled reception unit for navigation data as claimed in claim 3, characterized in that all the elements required for implementation are situated together inside one cohesive physical unit, which may also be the result of a modular design for the single components.

51. The processor-controlled reception unit for navigation data as claimed in claim 24, characterized in that all the elements required for implementation are situated together inside one cohesive physical unit, which may also be the result of a modular design for the single components.

52. The processor-controlled reception unit for navigation data as claimed in claim 26, characterized in that all the elements required for implementation are situated together inside one cohesive physical unit, which may also be the result of a modular design for the single components.

53. The processor-controlled reception unit for navigation data as claimed in claim 26 in combination with a coupleable computer, characterized in that the coupleable computer has one or more of the following properties:
a) the computer contains memory-resident software programs for personal task, appointment and e-mail management,
b) the computer contains at least one interface which is in the form of a radio interface,
c) the computer can be controlled using a touch-sensitive screen,
d) the computer contains a dialing device combined with a transmission and reception unit for mobile telephony,
e) the interface of the computer which is used by the reception element is externally inaccessible,
f) the computer weighs less than 200 grams after all the parts which can be detached without tools and which are not required for the intended operation have been removed,
g) the computer can be installed in the dashboard area of motor vehicles and can be removed from the motor vehicle without the use of tools,
h) the computer contains at least one slot for memories which is externally accessible without tools and which retains the memory content even when no power is supplied,
i) the solid state memory of at least 3 Mbytes which is used in the computer is FLASH memory.
